(19) United States
(12) Patent Application Publication
(10) Pub. No.: US 2003/0014854 A1
(43) Pub. Date: Jan. 23, 2003

(54) Transmission torque converter tool assembly

(76) Inventor: Keith A. Brown, Oakdale, MN (US)

Correspondence Address: Anthony G. Eggink, Anthony G. Eggink & Asocciates, 3100 First National Bank Building, 332 Minnesota Street, Saint Paul, MN, 55101, US

(21) Appl. No.: 09/909,036

(22) Filed: Jul. 19, 2001

(51) Int. Cl. B23P 19/04

(52) U.S. Cl. 29/426.5; 29/256

(57) ABSTRACT

A tool assembly for removing the torque converter from a transmission. The tool assembly is comprised of a brace member, a pair of elongated threaded bars with handles, and a cooperating pair of plate members. The brace member is constructed and arranged for mounting to the front of the torque converter and the plate members are constructed and arranged for mounting to the front of the transmission housing. The threaded bars are positioned in threaded apertures of the brace structure whereby turning of the threaded bars cause the assembly to engage and push against the press plates to pull and remove the torque converter from the transmission.

### BACKGROUND OF THE INVENTION

The invention relates to a tool assembly for removing a torque converter from a transmission. Particularly, the invention relates to a tool assembly that is constructed and arranged to be mounted to the transmission and is operational for separating and removing the torque converter from the transmission housing.

A torque converter is a component of an automatic transmission and is positioned at the front of the transmission to move with the flywheel of the engine. Two splined shafts, an inner shaft and an outer shaft, interact between the torque converter and other components of the transmission. The outer shaft, or Stater shaft, locks into the transmission and cooperates with the inner shaft or turbine shaft. The respective splined shafts are normally separated as the torque converter is pulled from the transmission, or in other words, as the turbine shaft is slid from the Stater shaft. However, when the turbine shaft is damaged, such as when the splines spread out or are in a frozen condition, the torque converter becomes difficult to remove from the transmission housing to thereby permit repair.

Transmissions that are damaged and need repair often require removing the torque converter from the transmission housing, particularly when the splines of the shafts are damaged. Depending upon the nature and extent of the damage, removing the torque converter may be extremely difficult. Due to the lack of tools designed to facilitate torque converter removal, the transmission and its components are often damaged during the time consuming removal process. For example, a chain lift hoist may be connected to bolt holes in the torque converter to pull the torque converter from the transmission; however, this process is often unsuccessful and may cause bodily injury and further damage to the transmission components.

A need exists in the industry for a tool assembly to remove a damaged torque converter from a transmission housing. And as far as is known, such tool assembly for efficiently and safely removing a torque converter from a transmission has not been utilized or proposed in the transmission maintenance and repair industry.

The torque converter removal tool assembly of the present invention is constructed and arranged to remove a torque converter from the transmission housing in a controlled and safe manner. The tool assembly is inexpensive, easy to utilize, and effective for safely removing the torque converter from the transmission.

### SUMMARY OF THE INVENTION

The transmission torque converter removal tool assembly of the present invention is comprised of a brace member and a means to apply a controlled force between the brace member and the transmission housing. The brace member has means to mount the brace member to the transmission housing. The means to apply a force between the brace member and the transmission housing is provided to cooperate with the brace member.

In one embodiment, the transmission torque converter tool assembly of the invention is comprised of a brace member and turning force means that cooperate with one or more press plates. The brace structure and press plates are constructed of a rigid material, such as metal. The brace structure is constructed to be mounted to the front of the torque converter and has a predetermined length so that when mounted, a portion of the brace is positioned in front of and in proximity to the transmission housing. Preferably the brace member is mounted using existing features of the torque converter.

The press plates are positioned between the transmission housing and the means to apply the force to thereby distribute the force over a larger area of the transmission housing. Preferably, the plates are mounted to the transmission housing using existing features, such as the threaded bolt apertures of the transmission housing.

The brace member is mounted to the transmission to enable a force to be applied between the brace and the transmission housing generally parallel to the axis along which the torque converter is inserted into or extracted from the transmission housing. The means to apply the force may include at least one threaded rod, a racheting device, a pneumatic device or other power means that provide a controlled force to move objects apart. By positioning one portion of the force means against the transmission housing and a portion of the force means, for example, the other end of the means against the brace structure, the effective length of the means between the points of contact can be increased to apply the force and separate the torque converter from the transmission housing.

The means to apply force may comprise a pair of T-bars or externally threaded rod members, each having a handle member at one end for turning the threaded portion of the rod member. The brace member includes threaded apertures to receive the threaded rods therethrough so that the ends opposite the handles engage the press plates. The handles of the threaded bar are then turned to increase the length of the threaded rods between the brace member and the transmission housing and to thereby forcibly separate the torque converter from the transmission housing.

The tool assembly may further include a means to secure the press plates and the ends of the threaded rods of the T-bars. For example, a sleeve member mounted to a press plate may be provided to receive the end of the threaded rod having a circumferential groove at its end. A locking pin projecting through the sleeve member may be provided to engage the recessed periphery of the rod end to thereby unite the press plate with respect to the brace member or tool bar.

Further provided are tool assembly structures and compositions used to provide effective and easy use of the torque converter removal tool assembly.

These and other benefits of this invention will become clear from the following description by reference to the drawings.

### DESCRIPTION OF THE DRAWINGS

FIG. 1 is a frontal plan view showing the transmission torque converter tool assembly of the invention mounted to a transmission for removing the torque converter;

FIG. 2 is a perspective view showing the tool assembly of FIG. 1;

FIG. 3 is a top plan view showing the brace member and cooperating threaded T-bar of the tool assembly;

FIG. 4 is a top view showing the press plate of the tool assembly; and

FIG. 5 is a lateral plan view showing the threaded rod end of a T-bar secured in the sleeve member of a press plate of the tool assembly.

### DESCRIPTION OF THE PREFERRED EMBODIMENTS

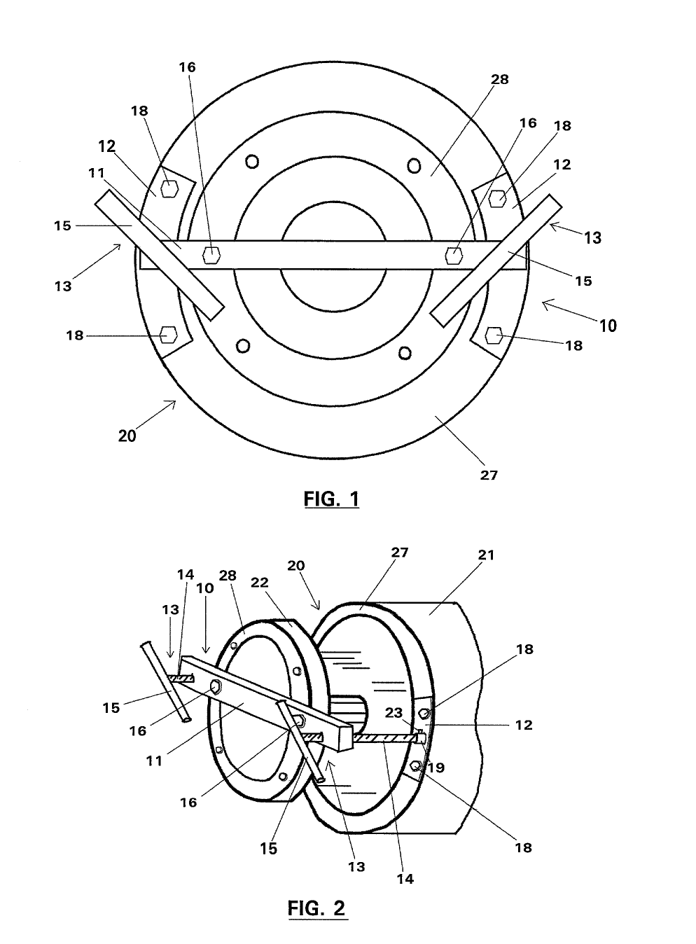

Referring to FIGS. 1 and 2, the present invention relates to a transmission tool assembly 10 for removing a torque converter 22 from a transmission 20. When a transmission 20 is in proper working condition, the torque converter 22 can typically be slid and removed from the transmission housing 21 by hand, however, when the splines engaging the transmission 20 and the torque converter 22 are damaged, the torque converter 22 may be frozen or wedged within the transmission housing 21. This invention relates to a tool assembly and process used to easily and safely remove a torque converter from within a transmission housing, which otherwise could not be easily and/or safely removed.

FIGS. 1 and 2 show the transmission torque converter tool assembly 10 used with respect to transmission 20. The tool assembly 10 is shown to be comprised of a brace member 11, a pair of threaded T-bars 13 and cooperating press plates 12. The transmission 20 is shown comprised of a transmission housing 21 having a front portion 27, and a torque converter 22 located therein and having a front portion 28. Specifically, FIG. 1 shows the torque converter 22 located within the transmission housing 21. To remove the torque converter 22 from the transmission housing 21, press plates 12 are shown mounted to the transmission housing front 27 and a brace member 11 is shown mounted to the torque converter front 28. The transmission housing front 27 is shown to have a plurality of existing threaded holes for attaching the press plates 12 using two pair of fastening bolts 18; likewise, the torque converter front 28 is shown to have a plurality of existing threaded holes for attaching the brace member 11 using mounting bolts 16, for example.

The T-bars 13 are shown to each have a threaded rod portion 14 and a handle member 15. A user grips the handles 15 and turns the T-bars 13 through the threaded rod apertures 17 of the brace member 11 so that the free end 29 of each threaded rod 14 pushes against the press plate 12. As is shown in FIG. 2, when T-bars 13 are turned and thereby push and apply force against press plates 12, the brace member 11 and the attached torque converter 22 move back in a direction along the length of the threaded rods 14. The torque converter 22 is thereby separated from the transmission housing 21 in a controlled manner.

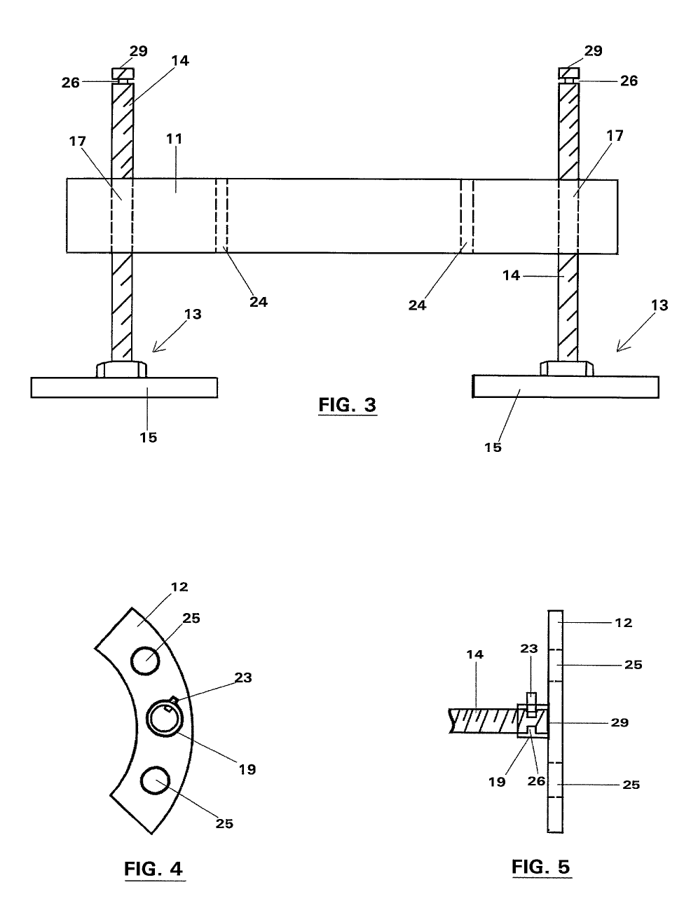

Referring to FIG. 3, the brace member 11 and T-bars 13 are shown. The brace member 11 is generally rectangular in shape and is comprised of a solid metallic material, for example. The brace member 11 has a predetermined length and width, depending upon the size of the torque converter 22 and the transmission housing 21 with which it is utilized. Also shown are the T-bars 13 which are turned through threaded apertures 17 of the brace member 11. Each T-bar structure 13 has of a threaded rod portion 14 and a handle portion 15. Also shown are mounting apertures 24 in the brace member 11, which receive mounting bolts 16 for attaching the brace member 11 to the torque converter front 28.

FIGS. 4 and 5 show a means to secure the free ends 29 of the threaded rods 14 to the press plates 12. The press plates 12 are attached to the transmission housing front 27 using fastening bolts 18 inserted through fastening apertures 25 of press plates 12. A sleeve or conduit member 19 is shown attached to each press plate 12 which is positioned between fastening apertures 25 and which is adapted to receive the free end 29 of the threaded rod 14 having a circumferential groove 26. For example, a metal conduit 19 may be welded to the press plate 12. A locking pin structure 23 projecting through the conduit 19 is provided to engage the circumferential groove 26 of threaded rod 14 to thereby lock the threaded rod 14 to the press plate 12. The locking pin 23 which may have biasing means rides in the circumferential groove 26 of the threaded rod 14 as the T-bar is turned.

The transmission torque converter tool assembly 10, as shown, is designed to remove the torque converter from an Allison AT 545 transmission, for example. Allison 545 transmissions are commonly used in school buses, garbage trucks, recycling trucks, street sweepers, rental trucks and the like. However, the tool assembly 10 may be constructed and arranged to be used on other transmission models.

For the Allison AT 545 transmission, the tool assembly 10 preferably has a brace member 11 constructed of solid 1½″ square steel stock, i.e., tool steel, having a length of approximately 20 inches, having mounting apertures 24 spaced approximately 12½ inches apart and having threaded apertures 17 spaced approximately 16 inches apart. The threaded rod portions 14 of the T-bars 13 are preferably approximately 7-8 inches in length, 1/2 inch D rods to engage the 1/2 inch D threaded apertures 17. The handle members 15 may be 7-12 inches in length to provide sufficient torque to turn the T-bars 13. The mounting apertures 24 are preferably 1/2 inch D to receive 3/8 inch D threaded bolts 16 that are bolted to the torque converter 22. The enlarged apertures 24 permit adjustment of the brace member 11 when mounted to the torque converter 22 and when the threaded rods 14 are positioned with respect to the press plates 12.

The press plates 12 are preferably 1/4 inch thick metal plates having fastening apertures 25 that are spaced and sized for receiving fastening bolts 18 that are sized to thread into pre-existing threaded apertures in the transmission housing 21. The tool assembly may use one or more press plates 12. For example, one continuous round press plate may be utilized for mounting to the transmission housing.

The process of using the tool assembly of this invention in removing the torque converter 22 from a transmission 20 comprises mounting the press plate(s) 12 to the exterior of the transmission case 21 and mounting the brace member 11 to the torque converter 22. Next, the T-bars 13 are threaded through threaded apertures 17 of the brace 11 to engage the press plates 12. The free ends 29 of the threaded rods 14 of the T-bars 13 are then secured in the respective conduits 19 of the press plates 12. Finally the handles 15 of the T-bars 13 are turned to separate and pull the torque converter 22 from the transmission case 21. In summary, the brace member and the means to apply a controlled force are mounted to the transmission and the torque converter and the force means is activated to provide a force between the brace member and the transmission housing.

As many changes are possible to the embodiments and process of this invention utilizing the teachings thereof, the descriptions above, and the accompanying drawings should be interpreted in the illustrative and not in the limited sense.

That which is claimed is:

1. A tool assembly for removing a torque converter from a transmission comprising:
a) at least one rigid plate structure for attachment to a transmission housing;
b) an elongated rigid member constructed and arranged for attachment to a torque converter within said transmission; and
c) at least one rotatable member, each having a length and being constructed and arranged for connection to and movement within each said plate structure and said elongated rigid member.

2. The tool assembly of claim 1, wherein each said rotatable member is an externally threaded rod and wherein said elongated rigid member further has internally threaded apertures for engagement with said externally threaded rod.

3. The tool assembly of claim 1, wherein each said rotatable member has a handle member and a circumferential groove near the end of said rotatable member opposite said handle member.

4. The tool assembly of claim 3, wherein each said rigid plate structure further has a means to capture said circumferential groove of each said rotatable member.

5. The tool assembly of claim 4, wherein said means to capture comprises a sleeve and a locking pin extending through said sleeve, and wherein said locking pin is constructed and arranged to engage said circumferential groove to secure said rotatable member to said plate structure.

6. The tool assembly of claim 1, wherein said tool assembly is constructed and arranged for use with an Allison AT 545 transmission.

7. A transmission torque converter tool assembly for removing a torque converter from within an automatic transmission housing, said assembly comprising:
a) a brace member having a means to mount said brace member to the front of the torque converter, whereby a portion of said brace member is positioned in front of and in proximity to the transmission housing; and
b) means to apply a force against said brace member and the transmission housing in a direction essentially parallel to the axis of insertion of the torque converter to separate the torque converter from the transmission housing.

8. The tool assembly of claim 7, further comprising at least one rigid plate member for positioning between the transmission housing and said means to apply a force.

9. The tool assembly of claim 7, wherein said means to apply a force comprises at least one threaded column; wherein said at least one threaded column has a length between the torque converter and the transmission housing; wherein said at least one threaded column has a first end and a second end; wherein the first end is positioned against the transmission housing; and whereby the length of said at least one threaded column is increased to apply the force.

10. The tool assembly of claim 9, wherein said at least one threaded column is an externally threaded rod; and wherein said brace member has at least one threaded aperture therethrough to receive therethrough said at least one threaded rod.

11. The tool assembly of claim 10, wherein said at least one threaded rod has a T-shaped handle attached to the second end for turning said at least one threaded rod.

12. The tool assembly of claim 7, wherein said brace member has a plurality of aligned mounting apertures for fastening said assembly to a torque converter.

13. The tool assembly of claim 9, wherein said at least one press plate has a means to secure said first end of said at least one threaded column to said at least one press plate.

14. The tool assembly of claim 7, wherein said assembly is constructed and arranged for removing the torque converter from an Allison AT 545 transmission.

15. The tool assembly of claim 13, wherein said at least one press plate has a conduit to receive the first end of said at least one threaded column; wherein the first end of said at least one threaded column has a circumferential groove; wherein said at least one press plate has a locking pin for engaging the circumferential groove and thereby locking the first end of said at least one threaded column to said at least one press plate; and wherein the first end of said at least one threaded column is locked to said at least one press plate.

16. The tool assembly of claim 7, wherein said brace member has a plurality of mounting apertures therethrough; wherein the mounting apertures are constructed and arranged so said brace can be mounted to the torque converter using a plurality of mounting bolts and pre-existing threaded holes in the torque converter; and wherein said brace is bolted to the torque converter.

17. A method for removing a torque converter from within an automatic transmission housing, said method comprising the steps of:
a) providing a brace member having a means to mount said brace to the front of the torque converter, whereby a portion of said brace member is positioned in front of and in proximity to the transmission housing;
b) mounting said brace member to the front of the torque converter; and
c) applying a force between said brace member and the transmission housing in a direction essentially parallel to the axis of insertion of the torque converter to separate the torque converter from the transmission housing.

18. The method of claim 17, wherein the step of applying a force is applied by turning the handle of at least one threaded rod.

19. A tool assembly for removing a torque converter from a transmission comprising:
a) at least one rigid plate structure for attachment to a transmission housing;
b) an elongated rigid member for attachment to a torque converter within the transmission, said rigid member having at least one internally threaded aperture;
c) at least one rotatable member, each said rotatable member having a cylindrical, externally threaded portion to provide a threaded engagement between each said rotatable member and each said aperture of said elongated rigid member; and
d) means to connect each said rotatable member to each said rigid plate structure.

20. The tool assembly of claim 19, wherein said means to connect each said rotatable member to each said rigid plate structure is comprised of an annular conduit connected to said plate structure and having a locking pin which extends through an aperture in said annular conduit.

21. The tool assembly of claim 20, wherein each said rotatable member has a first end and a second end and wherein said rotatable member has a peripheral recess near said first end which is constructed and arranged to receive said locking pin for securement within said annular conduit and to each said plate structure.

22. The tool assembly of claim 21, wherein each said rotatable member is T-shaped and has a handle portion located at said second end.

23. The tool assembly of claim 19, wherein said rigid member is constructed of solid 1.5 inch square steel stock and has a length of approximately 20 inches for use with an Allison AT 545 transmission, wherein said threaded portion of each said rotatable member is approximately 7 to 8 inches in length, wherein said handle portion is approximately 7 to 12 inches in length and wherein said plate members are approximately 0.25 inches in thickness.
